(19) United States
(12) Patent Application Publication
(10) Pub. No.: US 2009/0170483 A1
(43) Pub. Date: Jul. 2, 2009

(54) SYSTEM AND METHOD FOR TRANSMITTING INFORMATION USING A MOBILE PHONE

(75) Inventors: Bruce G. Barnett, Troy, NY (US); Christopher Donald Johnson, Clifton Park, NY (US); Amit Bhavanishankar Kulkarni, Clifton Park, NY (US); Michael James Hartman, Clifton Park, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company, Schenectady, NY (US)

(21) Appl. No.: 11/966,276

(22) Filed: Dec. 28, 2007

(51) Int. Cl. H04Q 7/22; H04M 1/00; G06Q 30/00

(52) U.S. Cl. 455/414.2; 455/550.1; 705/14; 705/26; 705/27

(57) ABSTRACT

A technique is provided for providing information to a customer within a store. A mobile phone is provided that is adapted to communicate with Near Field Communication (NFC) devices and wireless Internet Protocol (IP) based network, or Internet system, as well as operate as a cellular phone. The mobile phone is configured to bridge information between the various protocols used to enable the mobile phone to communicate with an NFC device, a wireless Internet system, and a cellular phone system. For example, information obtained by the mobile phone from a NFC device may be transferred to the portion of the mobile phone that is used to connect the mobile phone to a wireless Internet system to enable the mobile phone to provide the proper authentication to access the wireless Internet system. In addition, the mobile phone may be adapted to communicate using a Bluetooth communication system. Similarly, information from the Bluetooth portion of the mobile phone is shared with the other portions of the phone that communicate using other data protocols.

### BACKGROUND

The invention relates generally to a system and method of communicating shopping information between a consumer and a retailer. In particular, the invention relates to a system for enabling a consumer to obtain shopping information from a retailer, and the retailer to obtain information from the consumer, using a communication device, such as a mobile phone,

A lot of time is wasted by consumers during the process of shopping. For example, a consumer may go to a store to purchase an item and find on arriving at the store that the item is not in stock. In addition, even if the item is in stock, considerable time may be wasted looking for the item in the store. Locating a store employee to ask the employee a question about a product can also be very time consuming. There are many other examples of problems that a consumer can experience when shopping that lead to considerable amounts of time being wasted.

In addition, each consumer may have preferences that differ from other consumers, and which differ depending upon their location. A retailer typically likes to provide the best shopping experience to each consumer when they enter their store. Some consumers may prefer to shop anonymously, while other consumer's may wish to identify themselves to the retailer so that their shopping experience may be optimized for their individual preferences based on past experiences with the retailer.

Therefore, a technique is desired that would improve the efficiency of the shopping experience, both to the consumer and to the retail store owner. In particular, there is a need for a technique that reduces the amount of time that a consumer spends locating items, getting information about items, and purchasing an item. In addition, there is a need for a technique that would enable a consumer's shopping preferences to be identified by a retailer quickly and easily in order for the retailer to optimize the shopping experience for the consumer.

### BRIEF DESCRIPTION

A technique is provided for providing information to a customer within a store. A mobile phone is provided that in addition to operating with a cellular network, is also adapted to communicate with one or more additional wireless communication systems, such as Near Field Communication (NFC), IEEE 802.11, Wi-Fi, Bluetooth, or IEEE 802.15, The mobile phone is configured to bridge information between the various services available to the phone over these multiple networks. For example, information obtained by the mobile phone from a NFC device may be transferred to the portion of the mobile phone that is used to connect the mobile phone to a wireless network to enable the mobile phone to provide the proper authentication to access the Internet. In addition, the mobile phone may be adapted to communicate using a Bluetooth communication system. Similarly, information from the Bluetooth portion of the mobile phone is shared with the other portions of the phone that communicate using other data protocols. Devices equipped with this technology can communicate with other devices lacking some of the communication mechanisms, and through peer connections, act as a bridge between services and such devices.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a system to enable a consumer's NFC (Near Field Communication) communication device to receive information from a retailer in response to information sent to the retailer from a consumer's communication device, in accordance with an exemplary embodiment of the present technique;

FIG. 2 is a block diagram of a technique for enabling a retailer to provide information to a consumer, in accordance with an exemplary embodiment of the present technique;

FIG. 3 is a elevation view of a NFC communications device, in accordance with an exemplary embodiment of the present technique; and

FIG. 4 is a perspective view of a NFC and Wi-Fi-enabled mobile phone, in accordance with an exemplary embodiment of the present technique.

### DETAILED DESCRIPTION

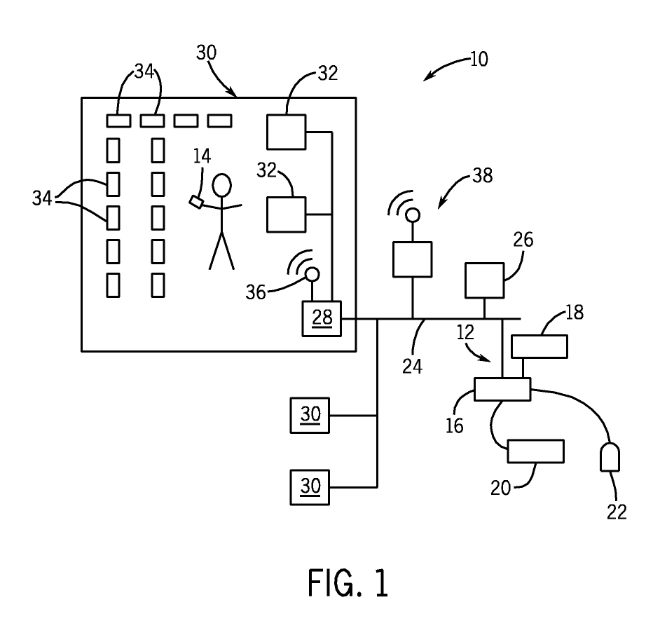

Referring now to FIG. 1, the present invention will be described as it might be applied in conjunction with an exemplary technique, in this case a system for providing a consumer's communication device with information from a retailer while the consumer is shopping in the retailer's store, as represented generally by reference numeral 10. In this embodiment of the system 10, a consumer may utilize a home computer system 12 or a portable communications device 14, such as a mobile phone, to request information from a retailer and/or to provide information to the retailer. The information transmitted to the retailer may include a shopping list of goods or services desired by the consumer. In return, the retailer may provide the home computer system 12 and portable communications device will information regarding the desired goods or services.

In the illustrated embodiment, the portable communications device 14 is a mobile phone that is adapted to operate as a cellular phone. In addition, the mobile phone 14 is adapted to communicate with a Near Field Communication (NFC) device, a wireless network, such as a Wi-Fi system, and a Bluetooth system, as well as a cellular phone system. The illustrated embodiment of the mobile phone 14 is configured with programming and hardware to share information between these different communication networks. This information sharing can simplify user interaction by enabling one communication network to provide information to be used by another communication network. For example, the user's name or the phone number stored in the cell phone may be used to authenticate access to a wireless Internet system. Alternatively, information obtained from an NFC device may be used to provide the authentication to use the wireless network. The mobile phone 14 is configured to bridge this information automatically. In effect, the mobile phone 14 combines the functions of a Wi-Fi device, a contact-less credit card, and a cell phone. A Wi-Fi device, a contact-less credit card, and a cell phone are three different “identities”. Normally, these identities are separate devices that operate independently. However, in this embodiment of the mobile phone 14, these three identities are combined into a unified package to manage their identities.

NFC is a short-range high frequency wireless communication technology which enables the exchange of data between devices over about a short distance, such as a decimeter. The technology is an extension of a proximity-card communications standard, i.e., a contact-less card or radio-frequency identification (RFID) standard that combines the interface of a smartcard and a reader into a single device. An NFC device can communicate with both existing smartcards and readers, as well as with other NFC devices. For example, an NFC device can act as a contactless smart card and interoperate with a terminal reader. This means that an NFC device can be a contactless credit card, a debit card, or even an electronic purse/wallet. An NFC device can also act as a smart card terminal and read contactless smart cards. In addition, an NFC device can communicate to other terminals in a peer-to-peer fashion. However, unlike smart cards which must be powered by an external RF field, an NFC-enabled mobile phone has its own battery. In addition, although the technique will be described in terms of using NFC technology, another short-range communication technology may be used. In this case, “short-range” refers to a wireless communications technology having an effective range of one meter or less.

The NFC protocol enables the mobile phone 14 to operate in several modes. One mode allows the phone to act as a passive tag, allowing a NFC terminal to read the information stored in the mobile phone 14. Another mode allows the mobile phone 14 to act as a terminal, allowing it to read information from another NFC device, such as a smart poster. Yet another mode allows the mobile phone 14 to act in a peer-to-peer exchange mode, whereby the mobile phone 14 may transmit and receive information between the mobile phone 14 and another NFC device.

The mobile phone 14 also is adapted to access a Wi-Fi system (IEEE 802.11). Wi-Fi is a wireless technology brand intended to improve the interoperability of wireless local area network products. Some applications for Wi-Fi include Internet and Voice-Over Internet Protocol (VoIP) phone access, gaming, and network connectivity for consumer electronics such as televisions, DVD players, and digital cameras. VoIP is a protocol optimized for transmission of voice through the Internet or other packet switched networks. VoIP is often used abstractly to refer to the actual transmission of voice, rather than the protocol implementing it.

The system 10 is adapted to provide information to a consumer's mobile phone 14 within a store without requiring the consumer to incur a mobile phone usage charge. That is, instead of using the data connection on a cellular carrier, the consumer uses a Wi-Fi network inside the store that has a connection to the Internet. Alternately, the device may communicate with a private network inside the store that is isolated from the Internet. For example, the system 10 is adapted to enable a consumer to obtain information regarding the availability, location, and/or price of the goods or services provided in the shopping list by using either the NFC capability of the mobile phone and/or the Wi-Fi capability of the mobile phone to receive information from the retailer within a retail store.

This embodiment of the mobile phone 14 also is adapted to communicate with IEEE 802.15-enabled components, which include Bluetooth, ZigBee, and other variations. Bluetooth is an industrial specification for wireless personal area networks (PANs). Bluetooth provides a way to connect and exchange information between devices such as mobile phones, notebook computers, desktop computers, printers, digital cameras, and video game consoles over a secure, globally unlicensed short-range radio frequency. In this example, the Bluetooth-enabled mobile phone would enable a consumer to access a retailer's communication system using a short-range radio frequency, rather than using the mobile phones cell phone capabilities, and charges. IEEE 802.15.4 devices provide low-rate mesh networking, allowing low-cost devices to form networks within the retail environment.

Multiple devices within a retail location may communicate using peer-to-peer mechanisms, and allow one device to act as a proxy for other devices. For example, one phone with NFC capability can pass information to other phones without NFC capability, allowing a consumer to share information with friends.

The home computer system 12 provides the consumer with an additional opportunity to communicate with the retailer. In addition, the home computer system 12 may communicate with the mobile phone 14. The illustrated home computer system 12 includes a computer 16, a monitor 18, a keyboard 20, and a mouse 22. The home computer system 12 may be a notebook computer. The home computer system 12 may also have a wireless router.

The home computer system 12 and mobile phone 14 are connected to the Internet 24 to enable the consumer to communicate with a retailer's central computing system 26, as well as other websites on the Internet 24. In this embodiment, the retailer's central computing system 26 is connected by the Internet to individual store computing systems 28 located within a store 30. However, another communications network may be used. In this embodiment, the central computing system 26 and each of the store computing systems 28 are used to host websites that may be accessed by either the home computer system 12 or the mobile phone 14. A consumer may access the websites to provide the retailer with the shopping list of desired goods and/or services. The retailer, in turn, may provide the home computer system 12 and/or mobile phone 14 with product information specific to each store, such as the availability of the products on the shopping list at a specific store and the location of the products on the shopping list at a specific store.

Within the store 30 are a series of displays 32 that are connected to the store computing system 28. In this embodiment, the displays 32 are NFC-enabled displays that can interact with a NFC-enabled mobile phone 14 using device-to-device communication. When a consumer enters the store 30, the consumer can place their NFC-enabled mobile phone 14 proximate to the display 32 to establish communications with the store computing system 28. For example, the mobile phone 14 may provide the display 32 with the identity of the customer. Thus, informing the store computing system 28 that the consumer is in the store 30. Shelves may also be outfitted with NFC devices if preferred by the merchant.

A display 32 may be as simple as a paper poster with a smart card located inside. This is referred to in the industry as a “smart” poster. A display 32 may also have a digital display with a contact-less card reader. The digital display may be touch-sensitive for user input. Some displays 32 may have cameras and audio input and output devices, such as for teleconferencing. Alternatively, the displays 32 may be Bluetooth-enabled communications devices. Similarly, when a Bluetooth-enabled mobile phone is located near the display 32, information is transmitted between the Bluetooth-enabled mobile phone 14 and the display 32.

Stand-alone NFC-enabled devices 34 that have been programmed with specific information are located around the store 30. In this embodiment, the stand-alone NFC-enabled devices 34 are used to identify products to NFC-enabled devices. The product identifiers 34 are located proximate to the products that they are used to identify, such as on a shelf supporting the product. In this embodiment, the product identifiers 34 are an RFID device, such as a contact-less smart card. When the NFC-enabled mobile phone 14 is placed proximate to the product identifier 34, the information is extracted from the product identifier 34 and transmitted to, and stored within, the NFC-enabled mobile phone 14 in a manner similar to a bar code reader. The information transmitted to the NFC-enabled mobile phone 14 from the product identifiers 34 may include the name of the product and the price of the product, as well as technical information about the product, such as the specifications.

In other embodiments, a similar device may be used to provide other types of information. For example, a similar NFC-enabled device may be programmed to provide the mobile phone 14 with the information needed to configure the mobile phone 14 for access to the wireless Internet system. Other NFC-enabled devices may be provided with similar configuration information. For example, a NFC-device may be programmed to provide a notebook computer that has NFC-capability with configuration information to enable the notebook computer to connect to a pay Wi-Fi system.

In addition, a connection through a NFC link indicates that the two devices are in close physical proximity to each other. If one device, such as a product identifier 34, is fixed at a known location, then the location of the other device, e.g., the mobile phone 14, can be inferred. This location information can be used to direct the consumer and can be used by the retailer to analyze traffic flows through the store.

As noted above, the store computing system 28 in this embodiment also comprises a Wi-Fi communication system 36. The store's Wi-Fi system can be used to retrieve more information about products using the information on the NFC tag located near the product. The Wi-Fi system 36 also enables the consumer to receive information by accessing the Internet 24. The consumer may use the mobile phone 14 to access the websites hosted by the central computing system 26 and/or the store computing systems 28, or any other website. For example, the mobile phone 14 may use the Wi-Fi system 36 to access the shopping list. As above, the information accessible from the Internet may be product information, such as the availability of products on the shopping list provided to the retailer, the price of the product, the location of the product, etc. In addition, the store 30 is informed that the customer is in the store 30 when the consumer connects the mobile phone 14 to the Wi-Fi system 36. The retailer may have difference classes of customers. More privileged customers may have greater access to services provided by the retailer than lesser privileged customers. For example, loyal customers may be provided promotional offers or greater Internet access.

The illustrated embodiment of the system 10 also comprises a cellular phone system 38. The cellular phone system 38 enables the consumer to use the mobile phone as a phone. In addition, the cellular phone system 38 also enables the consumer to use the mobile phone 14 to access the Internet. Information from the retailer may be provided to the mobile phone 14 via the cellular phone system 38.

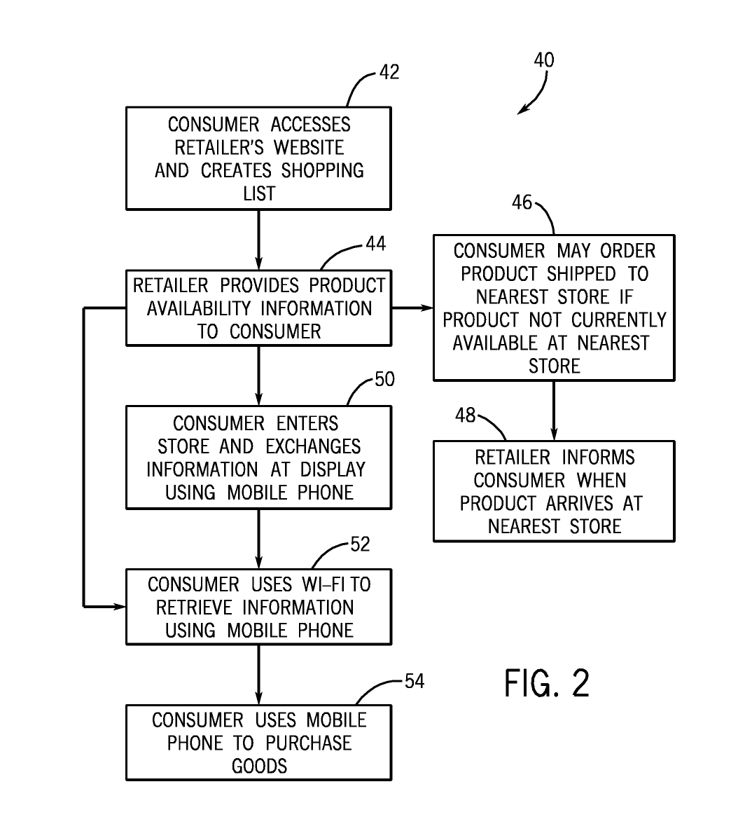

Referring generally to FIG. 2, an embodiment of a technique for using a NFC-enabled and Wi-Fi-enabled mobile phone 14 to receive information from a retailer is presented, and represented generally by reference numeral 40. In the illustrated embodiment, a user may access a retailer's website and create a shopping list of desired goods, as represented generally by block 42. The shopping list may be created using the home computer system 12 or the mobile phone 14. The shopping list may include the specific manufacturer of the product. The user may also specify their location (zip code, etc.), their wireless provider, and their account information.

The retailer then processes the shopping list and provides product information back to the user, as represented generally by block 44. The central computing system 26 and the store computing system 28 for the store 30 nearest the user may interact to identify whether the product, or products, on the shopping list are in the current inventory at desired store 30. The availability of the products at a desired store, such as the nearest store, is sent back to the user. The information may be accessed from the Internet by the mobile phone 14. Thus, the consumer has a copy of the shopping list in the mobile phone 14 that the consumer may carry with them.

The user may request the product be sent to the nearest store if it is not currently available at the nearest store, represented generally by block 46. The consumer may use the website to direct the retailer to send the product to the nearest store. The retailer may then inform the consumer when the product has arrived at the nearest store, as represented generally by block 48. The consumer may be notified that the product has arrived at the nearest store by a pop-up ad on the mobile phone 14, by an e-mail, by a phone call, etc. Alternatively, the location of the nearest store having the product may be provided.

When the consumer enters the store to obtain the goods on the shopping list, the consumer places their mobile phone 14 proximate to an NFC-enabled display 32 to exchange information with the retailer, as represented generally by block 50. The mobile phone 14 may receive information from the retailer, as well as provide the retailer with information. The information received from the retailer may include product information, such as the shopping list. The product information may include the location within the store 30 of the products on the shopping list. Promotional information, such as discounts, may also be received. The mobile phone 14 may be programmed to be in an operating mode to learn about the current store using the NFC display 32. For example, the mobile phone 14 may send a query to the NFC-enabled display 32 to inform the mobile phone 14 the identity of the retailer and the location of the retailer's store. This information may be used to configure the mobile phone 14 as a loyalty card for the specific retailer, as well. In addition, the mobile phone 14 may have privacy options that enable the user to select a specific privacy setting from a variety of privacy settings. For example, the mobile phone 14 may have an “anonymous” option so that the consumer may use some of the features the store provides, but the mobile phone 14 does not reveal the consumer's name to the store. Alternatively, the consumer may choose not to access an NFC-enabled display at all and thereby maintain complete privacy.

The information received from the NFC-enabled display 32 may be used to configure the mobile phone 14 for the specific retailer and/or the specific store. Normally, when a consumer goes to pay for a product, the payment terminal, such as a smart card reader, expects a credit card to provide the right data. Here, the mobile phone 14 may act as the credit card. However, the mobile phone 14 may be programmed with a plurality of different credit card numbers. In addition, the mobile phone 14 may be programmed to provide a specific credit card number when the mobile phone 14 is used in making purchases in a specific store. For example, the mobile phone 14 may be programmed to provide a first credit card number when the consumer is in a first store and provide a second credit card number when the consumer is in a second store. Here, once this information is initially programmed into the mobile phone 14, the configuration of the mobile phone 14 as a credit card is done automatically simply by placing the mobile phone 14 proximate to the NFC-enabled display 32 so that the desired information may be exchanged between the two. Thus, the consumer does not have to scroll through menus or follow any other time consuming process simply to configure the mobile phone 14 each time they make a purchase.

Other product information also may be retrieved. For example, as the consumer travels through the store 30, the consumer may see other items of interest. The consumer may hold their mobile phone next to a product identifier 34 and retrieve and store information regarding the product, such as the identity of the product. The consumer may then place the mobile phone 14 proximate to a NFC-display 32 which reads the product identity information from the mobile phone 14 and retrieves additional information regarding the product to the consumer. Other technologies could be used, such as having a bar-code scanner or a RFID reader built into the mobile phone 14. The consumer may also learn of other similar products through this mechanism, and therefore have more shopping choices, while allowing the retail store owner to provide custom shopping choices for the shopper.

Product location information my also be provided to assist consumers find items on their shopping list. The product location information may be a simple location, such as the row and aisle number, displayed either on the display 32 or the mobile phone 14. Alternatively, a set of directions may be provided to direct the consumer to the product. Other interactive mechanisms can be used to help the consumer find the item. If the mobile phone 14 has Global Positioning System (GPS) technology, the consumer may be directed to the product via GPS coordinates. Sensors in the store (cameras, motion, etc.) may also detect the consumer's location. The mobile phone 14 may provide a GPS-enabled map to guide the consumer to the product. If the mobile phone 14 is placed proximate to a product identifier 34 for a product on the shopping list, the mobile phone 14 may provide an audible beep when the proper product has been located with the mobile phone 14.

In addition, information to enable the consumer to use the store's Wi-Fi system 36 may be retrieved from the NFC-enabled display 32. In this embodiment, all of the information needed to automatically configure the mobile phone 14 to use the stores Wi-Fi system 36 is provided to the mobile phone 14 via the NFC-enabled display 32. For example, the mobile phone 14 may detect several Wi-Fi systems. However, the information from the NFC-display may enable the mobile phone to identify the specific Wi-Fi system in the store and automatically configure the mobile phone 14 accordingly. In addition, the URL for the store's website may be retrieved via the NFC-enabled display 32. Alternatively, the display may be configured as a Bluetooth display as discussed above. Once the mobile phone 14 has received the information the first time, the mobile phone 14 may remember the Wi-Fi connection and, at subsequent times, remember the Wi-Fi connection, so the consumer need not stop at the display 32 in the future to configure the mobile phone 14.

The consumer may use the store's Wi-Fi system 36 to search the Internet, as represented by block 52. Additional shopping information may be obtained by the consumer via the Internet. For example, the consumer may access a manufacturer's website to obtain additional information about a product. The consumer also may use the Wi-Fi system 36 for general entertainment purposes.

The consumer may use the mobile phone to purchase goods, as represented by block 54. The consumer can use the cell phone as a credit card to complete the purchase process by using a NFC-enabled payment register.

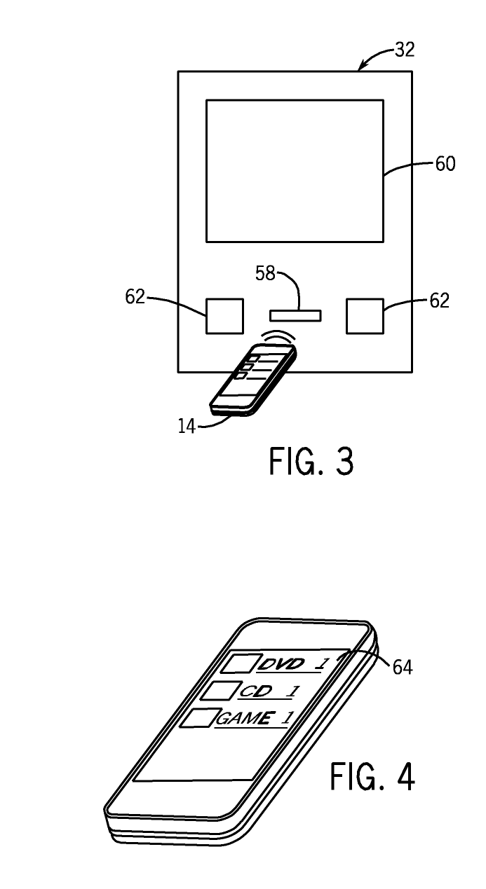

Referring generally to FIG. 3, an embodiment of a NFC-enabled display 32 is presented. The NFC-enabled display 32 has an NFC-interface 58 that is adapted to transmit data between the mobile phone 14 and the display 32. In addition, this embodiment of the display 32 has a monitor 60 and speakers 62 to enable video and audio interaction between the consumer and a representative of the retailer and/or the product manufacturer. The representative may be located at a remote facility and connected to the display via the Internet 24 and the store computing system 28. The representative may answer questions about the products on the shopping list. The representative may be selected based on their expertise on the product. Prior transaction information stored on the retailer's central computing system 26 may be transmitted to the representative to better guide the representative in their advice to the consumer. The displays 32 may have privacy shields so others cannot oversee or overhear the conversation with a representative.

In addition, the display 32 can offer answers to frequently asked questions about the products. The display 32 could be used to provide a link to external web sites that provide reviews and comparisons of a product on the shopping list. The display 32 can provide the consumer with promotional or additional offers. For example, the display 32 may provide sales offers for memberships, additional services, extended warranties, accessories, or even competing products at a lower price. Special package deals may also be offered to the consumer. Special prices can be extended to the consumer based on loyalty, past purchases, reputation, and/or excess inventory. The display 32 may also provide offers on items not in inventory, but that will be available soon. This information is stored in the mobile phone 14 and may be retrieved from the mobile phone 14 at check-out.

The display, using the NFC interface, may be used to complete the transaction using the cell phone as a credit card, debit card, or electronic purse. Any promotional or special offers stored in the mobile phone 14 are retrieved from the mobile phone 14 at check-out. As noted above, the technique may be used with a Bluetooth-enabled display, as well.

Referring generally to FIG. 4, an embodiment of a mobile phone 14 is presented. As noted above, this embodiment of the mobile phone 14 has NFC capability, Wi-Fi capability, and Bluetooth capability, in addition to having cellular phone capability. In this embodiment, a shopping list 64 is displayed on the mobile phone 14. Inside the mobile phone 14 are a cellular phone interface, a Wi-Fi interface, and a Bluetooth interface.

There are many ways that the consumer may benefit from the techniques described above. Generally the time that the consumer spends in a store may be used more efficiently. For example, the consumer knows immediately whether or not an item is in stock at a nearby store. In addition, there is less need to find a person at the store to obtain additional information. Obtaining unbiased information on new items is possible while in the store without having to connect to the Internet and/or Internet access is provided to the consumer in the form of a Wi-Fi system that may be accessed by the consumer's mobile phone. The most basic benefit is that a consumer is less likely to forget to buy an item if it's listed on a shopping list on their mobile phone. In addition, a consumer may receive special offers based on loyalty to the retailer or product manufacturer.

The retailer benefits from these techniques, as well. A retail store does not need as many people employed at the store to handle tasks like finding out if the item is in stock, finding out technical questions, etc. By not requiring product experts to be employed in each store, lower cost employees can be employed to work in the store. The store can attract those that don't like big box stores because the displays can provide more personalized and intelligent responses to their questions, combining canned responses with human interaction. People employed for their technical expertise can be located anywhere in the world, including countries where the labor costs are low. In addition, time is saved at the checkout line.

The technical effect of the technique is to enable information to be transmitted to and from a NFC-enabled mobile phone. While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of providing information to a customer, comprising:
reading data from a short-range wireless communication device using a short-range wireless communication-enabled mobile phone; and
accessing information via a communications network based on the data read from the NFC-enabled device.

2. The method of obtaining information with a mobile phone as recited in claim 1, wherein accessing information via a communications network based on the data read from the short-range wireless communication device comprises:
transmitting the data read from the short-range wireless communication device from the short-range wireless communication-enabled mobile phone to a short-range wireless communication device coupled to a communications network.

3. The method of obtaining information with a mobile phone as recited in claim 1, wherein accessing information a communications network based on the data read from the short-range wireless communication device comprises:
accessing the Internet using the short-range wireless communication-enabled mobile phone.

4. The method of obtaining information with a mobile phone as recited in claim 3, wherein the short-range wireless communication -enabled mobile phone is adapted to communicate via a wireless Internet system and accessing a communications network using the short-range wireless communication-enabled mobile phone comprises accessing the Internet using the wireless Internet system.

5. The method of obtaining information with a mobile phone as recited in claim 1, wherein accessing the Internet using the wireless Internet system comprises transferring data representative of the short-range wireless communication-enabled mobile phone wherein accessing information via a communications network based on the data read from the short-range wireless communication device comprises:

6. The method of obtaining information with a mobile phone as recited in claim 5, wherein presenting the information accessed from a communications network in at least one of a visual or audible form comprises presenting the information with the short-range wireless communication-enabled mobile phone.

7. The method of obtaining information with a mobile phone as recited in claim 1, wherein reading data from a short-range wireless communication device using a short-range wireless communication-enabled mobile phone comprises reading a website address from the short-range wireless communication device.

8. The method of obtaining information with a mobile phone as recited in claim 1, comprising:
identifying location of the short-range wireless communication-enabled mobile phone based on location of the short-range wireless communication device when data is read from the short-range wireless communication device.

9. The method of obtaining information with a mobile phone as recited in claim 1, wherein reading data from a short-range wireless communication device using a short-range wireless communication-enabled mobile phone comprises reading a product identifier from the short-range wireless communication device.

10. The method of obtaining information with a mobile phone as recited in claim 1, wherein reading data from a short-range wireless communication device using a short-range wireless communication-enabled mobile phone comprises reading promotional information from the short-range wireless communication device.

11. The method of obtaining information with a mobile phone as recited in claim 1, comprising:
transferring information from the short-range wireless communication-enabled mobile phone to at least one mobile phone.

12. The method of obtaining information with a mobile phone as recited in claim 1, comprising:
wherein the short-range wireless communication device is a Near Field Communication (NFC) device and the short-range wireless communication-enabled mobile phone is a NFC-enabled mobile phone.

13. A mobile phone, comprising:
a wireless phone protocol to enable the mobile phone to transmit information via a cellular phone system;
a Near Field Communication (NFC) protocol to enable the mobile phone to receive data from a NFC-enabled device; and
a wireless Internet protocol to enable the mobile phone to access the Internet via a wireless Internet system.

14. The mobile phone as recited in claim 13, wherein the mobile phone is adapted to enable information to be shared between the wireless phone protocol, the NFC protocol, and the wireless Internet protocol.

15. The mobile phone as recited in claim 13, wherein the mobile phone comprises:
a Bluetooth protocol to enable the mobile phone to transmit information to a Bluetooth-enabled device.

16. A method of providing information to a customer, comprising:
reading data from a first Near Field Communication (NFC)-enabled device using a NFC-enabled mobile phone;
storing the data in the NFC-enabled mobile phone; and
transferring the data stored in the NFC-enabled mobile phone to a second device.

17. The method of providing information to a customer as recited in claim 16, wherein the data comprises a promotional offer.

18. The method of providing information to a customer as recited in claim 17, wherein the second device comprises a transaction register.

19. The method of providing information to a customer as recited in claim 16, wherein the data comprises a product identifier and the second device is coupled to the Internet and adapted to retrieve product information based on the product identifier.

20. The method of providing information to a customer as recited in claim 16, wherein the second device is a second mobile phone.

21. A system to provide information to a customer, comprising:
a plurality of Near Field Communication (NFC)-enabled devices having data stored therein; and
a NFC-enabled device coupled to a communications network, wherein a customer may access shopping-related information via the communications network by retrieving the data from at least one NFC-enabled devices and transferring the data to the NFC-enabled device coupled to a communications network.

22. The system to provide information to a customer as recited in claim 21, wherein the data stored in at least one of the plurality of NFC-enabled devices comprises a promotional offer.

23. The system to provide information to a customer as recited in claim 22, wherein the NFC-enabled device coupled to a communications network comprises a transaction register.

24. The system to provide information to a customer as recited in claim 21, wherein the NFC-enabled device coupled to a communications network is adapted to retrieve product information from the communications network based on the data stored in at least one of the plurality of NFC-enabled devices.

25. A method of accessing the Internet with a wireless Internet communications device, comprising:
providing a wireless Internet system to enable a user to access the Internet; and
providing a Near Field Communication (NFC)-enabled device adapted to provide data to the wireless Internet communications device to enable the wireless Internet communications device to configure the wireless Internet communications device to communicate with the wireless Internet system.
